(19) United States
(12) Patent Application Publication
(10) Pub. No.: US 2006/0269133 A1
(43) Pub. Date: Nov. 30, 2006

(54) Systems and methods for information handling in an image processing system

(75) Inventors: David Jon Metcalfe, Marion, NY (US); James M. Ziobro, Rochester, NY (US)

Correspondence Address: OLIFF & BERRIDGE, PLC., P.O. BOX 19928, ALEXANDRIA, VA, 22320, US

(73) Assignee: Xerox Corporation, Stamford, CT (US)

(21) Appl. No.: 11/139,595

(22) Filed: May 31, 2005

(51) Int. Cl. G06K 9/34; G06K 9/00

(52) U.S. Cl. 382/176; 382/168

(57) ABSTRACT

A method for processing image data may include: generating a window mask that indicates which pixels are part of a window and generating raw window identifiers to be assigned to detected windows. The method may further include regenerating raw window identifiers from the window mask. For example, in an auto windowing image processsing system, a mask value may be stored in a page buffer, rather than a window identifier, so that less memory is required for the page buffer. In embodiments, the mask value may be a single bit while the window identifier is multiple bits.

### BACKGROUND

This invention is directed to systems and methods for an image processing system that improve information handling.

Scanners and other types of image capture devices, and digital copiers and other image forming devices, have become ubiquitous office productivity tools for generating electronic images of physical original documents or generating physical copies of electronic images. Once an electronic image has been generated, either from scratch or from a physical original document, the electronic image data can be used in an infinite variety of ways to increase the productivity and the product quality of an office. Image capture devices include desktop scanners, other stand alone scanners, digital still cameras, digital video cameras, the scanning input portions of digital copiers, facsimile machines and other devices that are capable of generating electronic image data from an original document, and the like. These image capture devices can also include image databases that store previously captured electronic image data. Image forming devices may include digital copiers, laser printers, ink jet printers, color ink jet printers, and the like.

As the costs of these various image capture devices and image forming devices have dropped and the output quality of the physical copies and the captured electronic image data has improved, these image capture devices and image forming devices have been provided with an ever increasing number of controllable features. Similarly, as users have become comfortable with capturing and using electronic image data obtained from original documents to create physical copies, the uses to which the electronic image data has been put, and thus the need to analyze the electronic image data, as well as the need to control the quality and appearance of the electronic image data and the physical copies, have expanded greatly.

For example, in the art image capture devices such as scanners, scanned image data may be processed according to the type of image data, for example, text, halftone, continuous tone (contone), or the like. Various technologies and techniques have been developed to process image data so that each different type of image data is processed differently so that the image data may be processed and rendered in an “optimized” manner, for example, to avoid visible artifacts in the processed output image.

For example, either at the user level control or through automated analysis of a scanned page of image data, the image data type of the page may be determined so that the image data of the scanned page is processed based on the determined image data type. This basic level of image processing only allows image data type-specific processing to be applied to the entire page, even when the page includes image data of more than one type.

A second approach includes pixel level analysis and classification. This approach may be known as pixel level segmentation or micro segmentation. A pixel classification function is used to analyze each pixel and classify each pixel as a particular type of image data. Each pixel is thus “tagged” with its classification. A given pixel's tag (classification) can be modified to take into account its surroundings. For example, the classification function may also be used to analyze the image data surrounding each pixel of image data to help determine the correct tag to assign to the given pixel. The tag assigned to each pixel is used to apply appropriate parameters and algorithms for processing and rendering each individual pixel.

A further development is automatic or automated windowing. In general, in automated windowing, each area, for example, of a scanned page, of a uniform type of image data is identified as a “window,” which may, for example, be processed uniformly based on its image data type. After pixels have been associated with the windows, statistics of the member pixels within identified windows as well as those of pixels outside of windows may be analyzed. Each pixel's tag may be re-specified based on the analysis, which may allow more tailored processing. For example, the processing of each pixel may be controlled by its tag as described in U.S. Pat. No. 5,513,282, the entire disclosure of which is incorporated herein by reference.

An exemplary apparatus and method for segmenting and classifying image data is discussed in U.S. Pat. No. 5,850,474, the entire disclosure of which is incorporated herein by reference.

### SUMMARY OF THE INVENTION

Exemplary embodiments of the systems and methods may reduce the amount of memory required for an image processing system.

For example, in an automated windowing image processing system, exemplary embodiments of the systems and methods may store a mask value in a page buffer, rather than a window identifier, so that less memory is required for the page buffer. In various exemplary embodiments, the mask value may be a single bit while the window identifier is multiple bits.

Various exemplary embodiments may provide a method for processing image data comprising: generating a window mask that indicates window membership/non-membership for each pixel. Various exemplary methods may further include regenerating raw window identifiers from the window mask.

In various exemplary embodiments, the window mask may comprise a raster collection of pixel window-mask bits.

Various exemplary embodiments may provide a system for processing image data comprising: a window detection module configured to generate a window mask that indicates window membership/non-membership for each pixel. Various exemplary systems may further include a re-tag module configured to regenerate raw window identifiers from the window mask.

Various exemplary embodiments may provide a machine readable medium that provides instructions for processing image data, the instructions, when executed by a processor, causing the processor to perform operations that include: generating a window mask that indicates window membership/non-membership for each pixel. Various exemplary embodiments may further include instructions that, when executed by a processor, cause the processor to perform operations that further include: regenerating raw window identifiers from the window mask.

These and other features and advantages are described in or are apparent from the following detailed description of various exemplary embodiments of systems and methods.

### BRIEF DESCRIPTION OF THE DRAWINGS

Various exemplary embodiments are described in detail, with reference to the following figures, wherein:

FIG. 1 is a block diagram illustrating an exemplary embodiment of an image processing system; and

FIG. 2 shows a flowchart outlining an exemplary embodiment of a method for image processing.

### DETAILED DESCRIPTION OF EXEMPLARY EMBODIMENTS

The following detailed description of exemplary embodiments is particularly directed to an image processing system that receives electronic image data from an image carried on an original document. Thus, the following detailed description of various exemplary embodiments of systems and methods will make specific reference to a scanner and processing of image data from an original document. However, it should be understood that the information handling systems and methods be used in conjunction with other image processing systems, and that the exemplary embodiments described herein are not limiting.

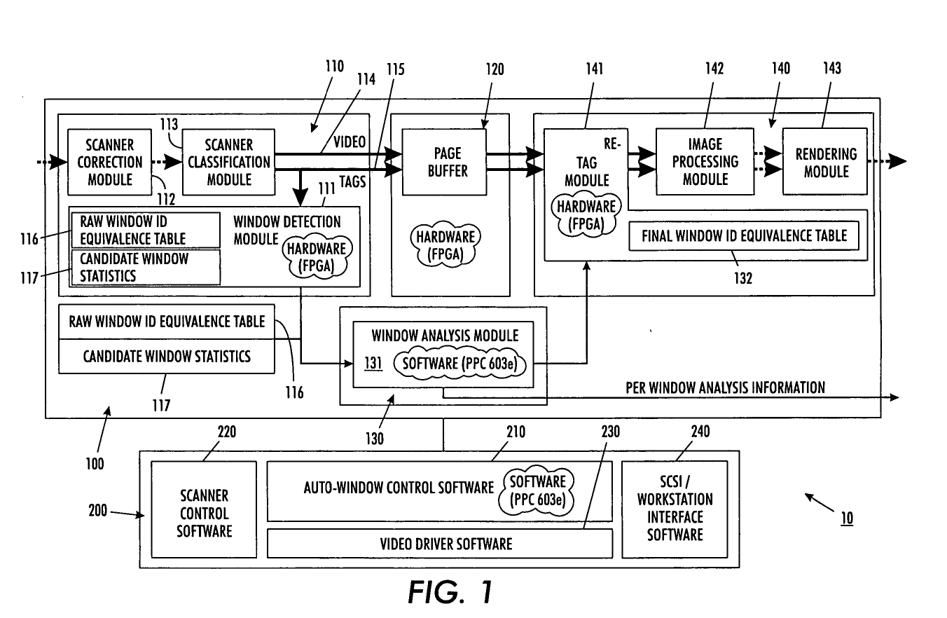

FIG. 1 illustrates an exemplary embodiment of an image processing system 10 usable with information handling systems and methods. As shown in FIG. 1, the image processing system 10 includes an image processing portion 100 and a control portion 200. While the image processing portion 100 and the control portion 200 are shown separately in FIG. 1, it should be understood that they need not be separate from each other and that the individual elements shown as contained in the image processing portion 100 or the control portion 200 may be located elsewhere as desired.

The image processing portion 100 may include a preliminary processing section 110, a page buffer 120, an analysis section 130 and a processing section 140. The preliminary processing section 110 includes a window detection module 111, and may further include additional modules, such as a scanner correction module 112 and/or a pixel classification module 113, for preliminary processing of image data.

The analysis section 130 includes a window analysis module 131. The processing section 140 includes a re-tag module 141, and may further include additional modules, such as an image processing module 142 and/or a rendering module 143, for processing and/or rendering image data.

The control portion 200 may include various control software for providing instructions to the various modules of the image processing portion to carry out their various functions, as discussed further below. For example, the control portion 200 may include auto-window control software 210 that provides instructions to the window detection module 111, the window analysis module 131 and the re-tag module 141. The auto-window control software 210 may also provide instructions to the pixel classification module 113, as well as any other element or module as needed to execute auto-windowing related tasks.

The control portion 200 may include additional software, such as scanner control software 220, video driver software 230 and/or SCSI/workstation interface software 240, as needed to execute other image processing related tasks. For example, the scanner control software 220 may provide instructions to the scanner correction module 112 and/or a scanner (not shown) used to input image data to the image processing system 10. The video driver software 230 may provide instructions, for example, to control all hardware portions of the video path. For example, the video driver software 230 may be implemented by one or more ASICs and/or FPGAs that provide detailed register level programming and control and real-time behavior/control. The SCSI/workstation interface software 240 may provide instructions, for example, to control the scanner via high level image processing commands, such as filtering, TRC, halftoning, error diffusing operations, and the like. The SCSI/workstation interface software 240 may provide control image processing operations without regard for the detailed register level programming and control or any real-time behavior/control. For example, the SCSI/workstation interface software 240 may be formed by many layers with intermediate abstractions of the desired functionality, but ultimately presents the desired functionality to the user in terms they can understand, such as Copy, Photo, Text, Brightness, Sharpness, Contrast, Magnification, and the like. Such user requests may be realized by assembling a set of image processing operations expressed as abstract terms to the scanner. The video driver software 230 may be used to realize the operations by providing control of the image processing hardware at the lowest level, for example. Concurrently, the scanner control software 220 makes the physical scanner scan and the image data flow through the appropriate image processing hardware. It should be understood, however, that control of the various elements and modules of the image processing portion 100 may be divided or combined in any desired manner, and may be provided by an overall control software or any combination of task-specific software as desired.

Image data is initially provided to the preliminary processing section 110 for preliminary processing and window detection. While image data may be input into the image processing system 10 in any known or hereafter developed manner, in the exemplary embodiment, for example, an original document having an image may be scanned to input image data into the preliminary processing section 110. The scanned image data may be provided to the scanner correction module 112 where the image data may be preprocessed to correct or compensate for undesirable characteristics of the scanner (or other input device or method). The scanner correction module may also perform any desired transformations of the image data, such as, for example, transformation of the image data to another color space for processing. Any preprocessing corrections, compensations and transformations, either known or hereafter developed may be applied as desired.

The adjusted or raw image data may be provided to the pixel classification module 113. The pixel classification module 113 identifies an image data type, for example, text, halftone, continuous tone (contone), or the like, for each pixel of the image data. The pixel classification module 113 may analyze the image data surrounding each pixel of image data to help accurately identify the image data type of each pixel. Each pixel is then “tagged” with its classification.

As shown in FIG. 1, the image data is communicated, for example, via a video channel 114, to be stored in the page buffer 120. The pixel tags assigned to each pixel by the pixel classification module 113 are also communicated, for example, via a tags channel 114, to be stored in the page buffer 120.

The window detection module 111 uses the video data and pixel tags assigned to each pixel to identify candidate windows, i.e., contiguous areas of the original document in which the image data and associated pixel classification tags suggest contiguity in terms of objects differentiated by the system. The window detection module 111 assigns a raw window identifier to each candidate window and collects statistics 117 regarding each candidate window based on the video and assigned pixel tags of the candidate window. Raster-order examination of the image data may result in detection and assignment of different raw window identifiers to multiple window segments that are later found to be connected, i.e., form a single window. Each raw window identifier may be, for example, a 14-bit number that is used to track candidate window information as the image data is analyzed.

The candidate window statistics 117 may be collected and stored in a table or any other suitable database. The window detection module 111 further develops a raw window identifier equivalence table 116 that documents connectivity detected for use by the system, for example, by window analysis module 131.

For example, for each pixel, there is an associated raw window identifier that is developed on the fly by the window detection module 111, both during the first pass and second pass, as opposed to conventional systems in which a raw window identifier is developed only in a first pass. Thus, as a given pixel is processed, the raw window identifier is known. Growing candidate windows may have entries in algorithm data structures to track boundaries along the fast scan direction, and in other data structures to hold the accumulating statistics. In the event that an existing raw window identifier on the present line is discovered to adjoin a different raw window identifier on the previous line, the present raw window identifier is used to index into the raw window identifier equivalence table and the raw window identifier of the newly encountered adjoining but pre-existing candidate window is stored in the raw window identifier table at that position. The roles of the present and the adjoining candidate windows may be reversed so that the present raw window identifier is stored at the index of the adjoining window, but a consistent methodology should be followed to enable distillation of complex topologies to describe a single composite window. At the time of initial allocation of a raw window identifier, the window identifier is itself is stored in the raw window identifier equivalence table at its own index, in effect pointing to itself. At the end of the page the window detection module traverses the chain of connected windows, collapsing them to all point to a single base window so that multiple levels of indirect references are not needed to understand window membership. The order of connection is not necessarily important, just that the windows are connected.

Allocation and management of the raw window identifiers, the analysis of the image data, as well as development of the raw window identifier equivalence table 116, are not material to this invention, however. Any suitable approach, either know or hereafter developed, may be used.

The window detection module 111 further generates a window mask based on the evaluation of each pixel that identifies whether each pixel was detected as a window segment of a candidate window. The window mask may comprise a raster collection of pixel window mask bits.

Each pixel window mask bit may be, for example, a single bit that indicates that a pixel is a “window pixel” or a “non-window pixel.” The pixel window mask bits, for example, in raster format correlating with the original raster image, are stored in the page buffer 120. This is referred to as the window mask for the image.

For example, where the pixel window mask bit is a one, the associated pixel is part of a candidate window. Where the pixel window mask bit is a zero, the associated pixel is not part of a candidate window. For example, when a mask bit raster is printed, the ones might be black and the zeros white, illustrating the window areas.

While the window mask is described herein in terms of a one bit per pixel window mask, it should be understood that various techniques of encoding and/or compression may be employed.

The raw window identifier equivalence table 116 and the candidate window statistics 117 are generated by the window analysis module 131. The window analysis module 131 analyzes the candidate window statistics 117 to identify final windows from the candidate windows. Each final window is assigned a final window identifier. Each final window identifier may be, for example, a 14-bit number that is used to track final window information as the image data is further processed.

Then, the window analysis module 131 classifies each final window based on the overall image data type of the final window, for example, based on the pixel tags of the pixels within the final window. Based on the classification and the gathered statistics, the window analysis module 131 may determine and assign (new) tag values for pixels within the window.

The window analysis module 131 further develops a final window identifier equivalence table 132. For example, each pixel may be associated with a candidate window by the raw window identifier that is developed in real-time as data flows into the re-tag module 141. This association is absolutely identical to the association developed during the first pass. Because this association by the re-tag module 141 is anticipated, the window analysis module 131 generates the final window identifier equivalence table 132 such that when each pixel's raw window identifier is used to index the final window identifier equivalence table 132, each table entry will contain the 8 bit tag value that is to be associated with this pixel downstream. This value is simply substituted for whatever tag is provided from the page buffer 120. For pixels outside of a window, the table 132 simply contains the same value as the raw window identifier used as an index. For pixels which are members of windows, the table 132 contains a unique tag value for that window. All raw window identifiers that were determined to be part of the same window are mapped to the same final window identifier. If the window analysis module 131 finds that the window candidate statistics 117 are confusing or indicate a window type for which there is no special rendering, the window analysis module 131 maps the raw window identifiers to themselves so that the pixel tag value does not change.

The final window identifier equivalence table 132 may be considered as a simple lookup table. The content of the final window identifier equivalence table 132 may be generated, for example, by a network of digital logic and lookup tables programmed by the window analysis module 131. However, the actual contents of the final window identifier equivalence table 132 is not the desired final window identifier at all, but rather the right input to the re-tag module 141 which, when combined with the other inputs, will result in the desired final window identifier.

It should be understood that other information may be piggybacked on the tags in the page buffer 120 or other information may be developed as the video flows out of the page buffer 120 into the re-tag module 141. However, for the sake of simplicity, additional details that are not pertinent to the disclosure of this invention are omitted. In other words, the exact nature of the information in the final window identifier equivalence table 132 and exactly how the final window identifier equivalence table 132 is generated may vary.

The final window identifier equivalence table 132 is used to map the raw window identifiers to the final window identifiers, as discussed above and below.

The image data, the pixel tags and the window mask is accessed from the page buffer 120 by the re-tag module 141. The re-tag module 141 receives the information in the final window identifier equivalence table 132 and obtains any other information, such as conversion parameters, based on the candidate window statistics from the window analysis module 131 that may be desired.

The re-tag module 141 may provide a two-step mapping in areas corresponding to final windows of the pixel tags to final window identifiers and then to application specific tags. The re-tag module 141 regenerates the raw window identifiers based on the window masks that were stored in the page buffer 120. This may be done in any known or hereafter developed manner. The regenerated raw window identifiers are then indexed into the final window identifier equivalence table to map to the final window identifiers, as discussed above. Each pixel of the image data is thus assigned a final window identifier. The final window identifier may then be converted to one or more application specific tag streams to control downstream processing, for example, by the imaging processing module 142.

The image processing module 142 may process the image data appropriately in accordance with the final window tags, for example, which may include the image data type of the pixel, other results of the statistics analysis, and/or other per-pixel information. The final window tags thus allow the processing to be “optimized” based on the content of the image data of the pixel rather than generically based on the image data type of the pixel.

The image data processed by the image processing module 142 may be output in the original form, such as gray-linear, or rendered by the rendering module 143 into a different representation of the image, such as spatially dithered binary. The goal of rendering is to provide the image data to a receiver in such a way that the receiver faithfully conveys the image, for example, of the original document, as desired by a user. Thus, the processing by the image processing module 142 may appropriately alter the image data so that the rendering module 143 outputs a desired image. Alternatively, or in addition, the provided rendering module 143 may use the final window tags in the process of rendering to output a desired image.

As described above, according to exemplary embodiments, the raw window identifiers are not stored in the page buffer 120. Rather, only the window mask is stored in the page buffer 120 and later used to regenerate the raw window identifiers. Window mask information may be significantly smaller than the data size of the raw window identifiers. For example, as discussed above, the window mask may be a single bit per pixel, while each raw window identifier is multiple bits per pixel. Thus, less memory in the page buffer is required to store the window masks. In some implementations, this may be synergistic with other system characteristics. For example, the window mask may be able to occupy an unused bit in an 8 bit page buffer byte used to store the pixel tag, where this 8 bit width is driven by industry standard memory width. Further, the window mask may lend itself to more efficient forms of encoding and communication.

Further, factors such as scanner noise, document characteristics, and the like, typically cause the window detection module 111 to generate hundreds or even thousands of raw window identifiers that are never even associated with a final window identifier. Thus, the number of raw window identifiers may be significantly large. Increased memory in the page buffer 120 would be required to store a raw window identifier with each pixel. For example, a document or other source of image data may include on the order of 33,000,000 pixels, requiring 33,000,000 window identifiers.

The processing portion 100 and the control portion 200, as well as the various elements, modules and software, may communicate via any suitable link(s), including interconnects within a single integrated circuit, direct printed wiring board trace connection, a direct cable connection, a connection over a wide area network or a local area network, a connection over an intranet, a connection over an extranet, a connection over the Internet, or a connection over any other distributed processing network or system. In general, such a link(s) can be any known or later developed connection system or structure usable to provide communication between the respective elements, modules and software. It should also be appreciated that the link(s) can be wired or wireless links, for example, that use portions of the public switch telephone network and/or portions of a cellular communication network.

The page buffer 120 may be any suitable type of memory, either known or hereafter developed.

It should be understood that each of the elements and modules of the image processing system 10 shown in FIG. 1 can be implemented as portions of a suitably programmed general purpose computer. Alternatively, each of the elements and modules shown in FIG. 1 can be implemented as physically distinct hardware circuits within a ASIC, or using a FPGA, a PLD, a PLA, or a PAL, or using discreet logic elements or discreet circuit elements. The particular form each of the elements and modules of the image processing system 10 shown in FIG. 1 will take is the result of a complex network of design tradeoffs which is the ordinary process of those skilled in the art.

Moreover, the elements of image processing system 10 can each be implemented as software, microcode, or state machines executing on a programmed general purpose computer, a special purpose computer, a microprocessor or the like. In this case, the image processing system 10 can be implemented as routines embedded in a peripheral driver, as a resource residing on a server, or the like.

The image processing system 10 can also be implemented by physically incorporating it into a software and/or hardware system, such as the hardware and software systems of a digital copier or the like.

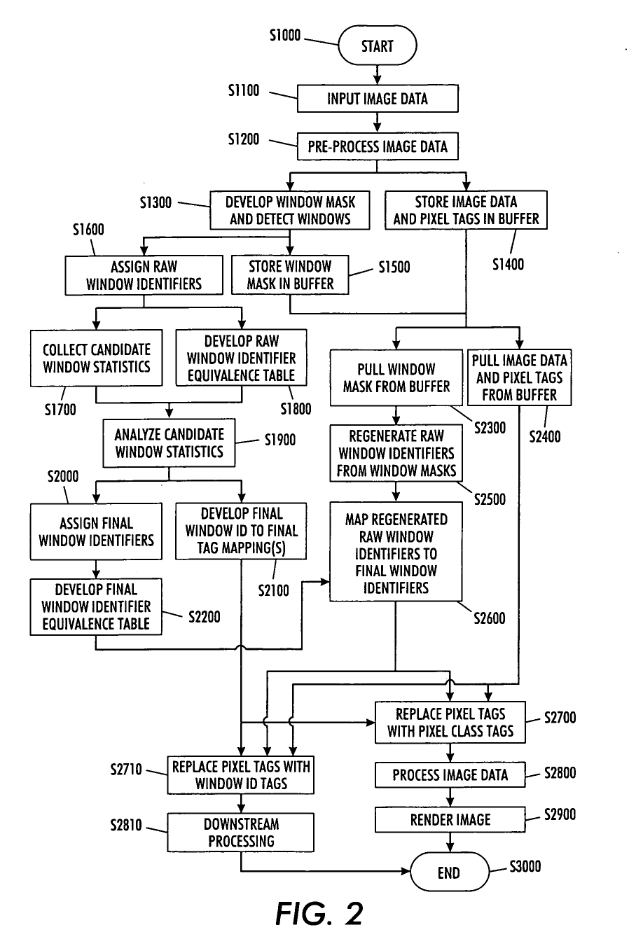

FIG. 2 illustrates a flowchart outlining an exemplary embodiment of a method for information handling. Although various steps relating to the exemplary embodiment of image processing are set forth, it should be understood that not all of the steps discussed are required, and that some of the steps may be optional for a given application of processing image data. Further, the order of the steps is exemplary and it should be understood that various steps may occur concurrently or may be combine and/or split.

Beginning in step S1000, control may continue to step S1100. In step S1100, image data may be input in any known or hereafter developed manner, for example, by scanning. Next, in step S1200, the image data may be processed in accordance with any desired preliminary processing, such as discussed above. Such preprocessing may include assigning a tag to each pixel based on a classification of the image data type of the pixel. In step S1300, a window mask may be developed and windows may be detected. As discussed above, the window mask may be developed based on the evaluation of each pixel that identifies whether each pixel was detected as a window segment of a candidate window. Also as discussed above, the image (video) data and the pixel tags may be used to identify candidate windows. However, it should be understood that any technique, either known or hereafter developed, may be used to detect windows.

In step S1400, the image data and pixel tags may be stored in a buffer. Similarly, in step S1500, the window mask may be stored in the buffer.

In step S1600, raw window identifiers may be assigned to the candidate windows. In step S1700, statistics of the candidate windows may be collected. Also, based on the assigned raw window identifiers, a raw window identifier equivalence table may be developed in step S1800.

In step S1900, the candidate windows statistics and the raw window identifier equivalence table may be accessed. The statistics may be analyzed to identify final windows from the candidate windows. Based on the analysis, final window identifiers or window tags may be assigned to the final windows in step S2000. Further, in step S2100, one or more final window ID to final window tag mappings may be developed. In step S2200, a final window identifier equivalence table may be developed based on the assigned final window identifiers.

In step S2300, the window mask stored in the buffer may be accessed. Similarly, in step S2400 the image data and the pixel tags stored in the buffer may be accessed. In step S2500, raw window identifiers may be regenerated, for example, as previously generated. The regenerated raw window identifiers may then be mapped to final window identifiers using the window mask and the final window identifier equivalence table in step S2600.

In step S2700, the pixel tags may be replaced with pixel class tags in accordance with the final window identifiers and/or the final window ID to final tag mapping(s). Alternatively, in step S2710, the pixel tags may be replaced with window ID tags. Steps S2700 and S2710 may follow any of steps S2100, S2400 and S2600, as illustrated in FIG. 2.

The image data may be processed based on the assigned pixel class tags or the window ID tags, respectively, in steps S2800 and S2810. In step S2900, the image may be rendered, for example, for a desired output device. Control may end in step S3000.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. An image processing system, comprising:
a window detection module configured to generate a window mask that indicates on a pixel by pixel basis whether the pixels are part of a window, and configured to generate raw window identifiers to be assigned to detected windows.

2. The system of claim 1, further comprising a re-tag module configured to regenerate raw window identifiers from the window mask.

3. The system of claim 1, wherein the window detection module is configured to generate the window mask as aggregated from a single bit associated with each pixel indicating status of that pixel as part of the candidate windows.

4. An image processing method, comprising:
generating a window mask that indicates which pixels are part of a window; and
generating raw window identifiers to be assigned to detected windows.

5. The method of claim 4, further comprising regenerating raw window identifiers from the window mask.

6. The method of claim 4, wherein generating the window masks comprises generating a single bit mask that indicates which pixels are part of a window.

7. A machine readable storage medium, comprising instructions for image processing, the instructions, when executed by a processor, causing the processor to perform operations that include:
generating a window mask that indicates which pixels are part of a candidate window; and
generating raw window identifiers to be assigned to detected windows.

8. The medium of claim 7, the instructions, when executed by a processor, causing the processor to perform operations that further include:
regenerating raw window identifiers from the window mask.

9. The medium of claim 7, wherein generating the window masks comprises generating a single bit mask that indicates which pixels are part of a window.
